(19) United States
(12) Patent Application Publication
(10) Pub. No.: US 2011/0202863 A1
(43) Pub. Date: Aug. 18, 2011

(54) Computer Entertainment Tracker Application for Limiting Use of Specific Computer Applications and Method of Use

(76) Inventor: Charles Shane CORRALLO, Sugar Land, TX (US)

(21) Appl. No.: 13/031,032

(22) Filed: Feb. 18, 2011

Related U.S. Application Data
(60) Provisional application No. 61/305,834, filed on Feb. 18, 2010.

(51) Int. Cl. G06F 3/048

(52) U.S. Cl. 715/772

(57) ABSTRACT

A computer application usage limiter that uses a method of credits to permit entertainment application usage. Users perform tasks to earn credits for using the entertainment applications. Administrators review the completed tasks to grant the users the credits.

The current application claims a priority to the U.S. Provisional Patent application Ser. No. 61/305,834 filed on Feb. 18, 2010.

### FIELD OF THE INVENTION

The present invention relates generally to a software application, more specifically, allowing parents and guardians to establish routines of tasks and chores that their children complete to earn rewards.

### BACKGROUND OF THE INVENTION

In the present day, the computer is a ubiquitous tool that can be found in almost every household in the US. The computers were originally developed as a means to make more complex calculations. However, as technology evolved, the number of available functionalities for the computer has significantly increased. The functionalities of the computer now spans across a large number of different categories including graphics creation, communication, electronic documents, and entertainment. However, one of the largest markets today for the computer relates to applications created for entertainment. The entertainment features that the computers are able to provide today include watching movies, listening to music, chatting with friends, and games. Although, these forms of entertainment are great activities to relieve stress and is able to combat boredom, the entertainment provided by the computer can easily become addicting. The addiction of computer entertainment can cause users to remain inactive and unproductive. Many of the entertainments provided by computers are marketed and aimed at children these days. The present invention serves to prevent children from excessively using the computer and balance it with more productive activities. The primary objective of this invention is to provide software that allows parents to create a schedule of chores and tasks, for each of their children, on the computer. The parents decide how many ‘credits’ completing each task or chore is worth. Children then complete the tasks and chores and the software keeps track of how many credits they have earned. After earning credits, the child may use the credits to ‘unlock’ their favorite computer games and Internet access.

### BRIEF DESCRIPTION OF THE DRAWINGS

FIG. 1 is the computer programming usage limiter and is accessible only be an administrator account.

FIG. 2 is the process for the user to obtain credits.

FIG. 3 is the process that allows the user to access the plurality of entertainment application.

FIG. 4 shows the user account depleting the number of credits available, causing the application monitoring manager module to terminate the operation of the plurality of entertainment application.

### DETAIL DESCRIPTIONS OF THE INVENTION

All illustrations of the drawings are for the purpose of describing selected versions of the present invention and are not intended to limit the scope of the present invention.

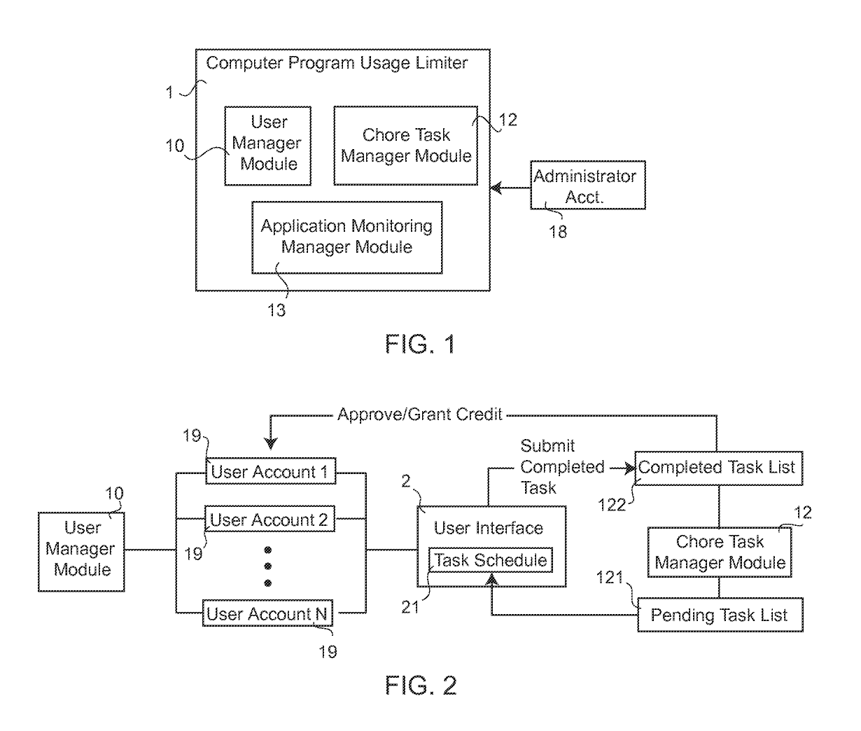

The present invention is a computer entertainment tracker application that provides parents or guardians to limit the use of any computer applications that are specified. The computer entertainment tracker application comprises of a computer program usage limiter 1 and a user interface 2. The computer program usage limiter 1 further comprises of a user manager module 10, a chore task manager, a chore task manager module 12, and an application monitoring manager module 13. In the preferred embodiment of the present invention, the computer entertainment tracker application is a Microsoft .NET windows application. However, the application be programmed in other software frameworks to correspond to the computer using the present invention. Parents (herein after referred to as administrator) being the administrators of the present invention are provided with an administrative account and are able to control the computer program usage limiter 1. In reference to FIG. 1, the administrator is able to access the user manager module 10 by means of the administrator account 18. The administrators controlling the present invention is able to use the user manager module 10 to create, edit or delete at least one user account 19. The administrator can also use the user manager module 10 to create additional administrator account 18s for other parents or guardians. Each of the user account 19s are managed and stored in the user manager module 10. The at least one used accounts are the accounts that are assigned to the children (herein after referred to as user) to access the user interface 2. The present invention is able to limit computer entertainment usage of the users by providing each of the user account 19s with a number of credits 191. Each of the credits provided to the user account 19 is valued by a predetermined usage time where they can operate an entertainment application. The administrator is able to edit specific user account 19 to modify access to a plurality of entertainment application 131.

In reference to FIG. 2, the chore task manager module 12 comprises of a pending task list 121 and a completed task list. The administrators are able to access the chore task manager module 12 by means of the administrator account 18. The administrators are able to add tasks and chores to the pending task list 121 by means of the chore task manager module 12. Each user account 19 is associated to a task schedule 21 provided by the user interface 2. The administrator is able to assign chores and tasks from the pending task list 121 to a specified user account 19 from the at least one user account 19. Each chore and task is associated with a predetermined number of credits 191 and stored to the task schedule 21 when assigned. The user is able access the user interface 2 by logging on with the at least one user account 19. By accessing the user interface 2 the user is able to access the task schedule 21 to see which tasks or chores need to be performed. Once the user completes the task, the user is able to mark the task as completed to notify the chore task manager module 12. The completed task is stored into the completed tasks list and associated to a user account 19 of the at least one user account 19s. The completed task lists having a plurality of completed task entries will await review and approval by the administrator. When the plurality of completed tasks entries is approved by the administrator, the predetermined number of credits 191 associated with the chore or task is granted to the at least one user account 19. The user can also opt to convert the credits to a cash value that is also predetermined.

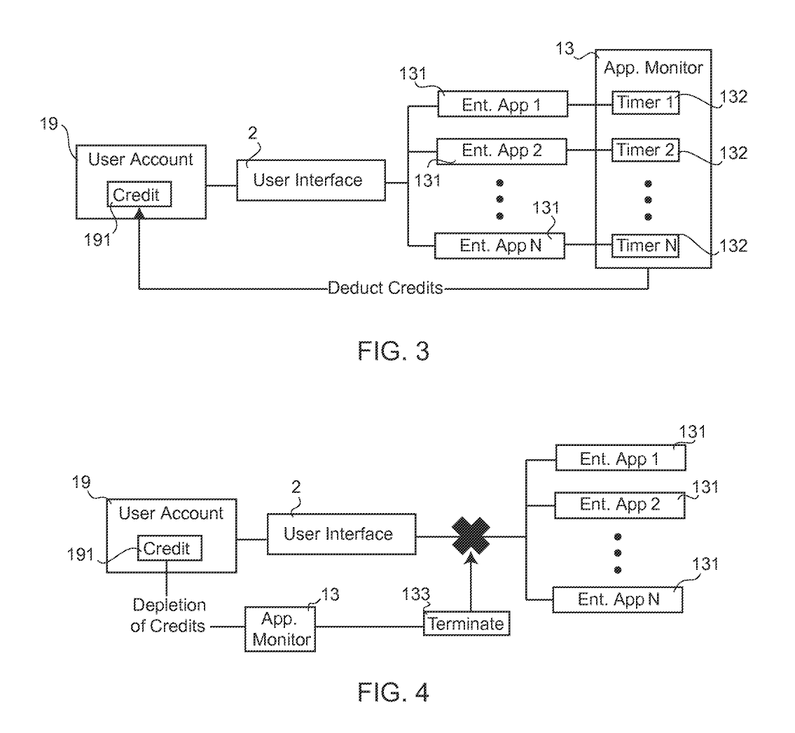

In reference to FIG. 3, the application monitoring manager module 13 allows the administrator to monitor the usages of different entertainment applications and comprises of an entertainment application list that is associated with a plurality of entertainment application 131s. The administrator is able to access the application monitor manager module by means of the administrator account 18. Using the application monitoring manager module 13, the administrator is able to add any installed entertainment applications to the entertainment application list. The computer program usage limiter 1 refers to the entertainment application list to lock down and restrict the operation of the plurality of entertainment application 131. In another embodiment of the present invention, the administrator can specify the amount of credits used per time each for every specific application. For example, some entertainment applications may be unhealthy while others may be more educational. The less healthy applications can be modified to deduct more credits per time period than the educational applications.

In reference to FIG. 4, the user is able to access the plurality of entertainment application 131 through the user interface 2 by utilizing the number of credits 191 associated to their user account 19. The computer program usage limiter 1 is able to limit the usage time for each of the individual entertainment applications of the plurality of entertainment application 131s based on the number of credits 191 associated with the user account 19. To limit the usage time, the application monitor manager module further provides a timer 132 and an automated exit signal 133. While the user is operating the entertainment application, credits are deducted from the balance associated with their user account 19. The timer 132 is initiated for each individual entertainment application and allows the computer program usage limiter 1 to deduct credits every time the predetermined usage time elapses during the use of each entertainment application. Once all the number of credits 191 associated with the user account 19 is depleted, the computer program usage limiter 1 sends the automated exit signal 133 to the computer to terminate all operating entertainment applications. To keep the plurality of entertainment application 131 operation, the user will need additional credits. To gain additional credits, the user must earn them through performing additional tasks and chores.

Although the invention has been explained in relation to its preferred embodiment, it is to be understood that many other possible modifications and variations can be made without departing from the spirit and scope of the invention as hereinafter claimed.

What is claimed is:

1. A computer entertainment tracker application for limiting use of specific computer applications comprises,
a computer program usage limiter;
a user interface;
the computer program usage limiter comprises a user manager module, a chore task manager module, and an application monitoring manager module;
the user manager module having at least one user account;
the chore task manager module having a pending task list;
the application monitoring manager module comprises a timer;
the application monitoring manager module having an entertainment application list associated with a plurality of entertainment application; and
the user interface comprises of a task schedule.

2. The computer entertainment tracker application for limiting use of specific computer applications as claimed in claim 1 comprises,
the at least one user account having a number of credits, wherein the number of credits permits access to the plurality of entertainment application; and
the computer program usage limiter limits the use of the plurality of entertainment application based on the number of credits associated with a user account.

3. The computer entertainment tracker application for limiting use of specific computer applications as claimed in claim 2 comprises,
the chore task manager module having a list of completed task; and
the list of completed task comprising of a plurality of completed task entries, wherein each of the completed task entries is associated to the at least one user account and each completed task is associated to a predetermined number of credits.

4. The computer entertainment tracker application for limiting use of specific computer applications as claimed in claim 2 comprises,
wherein each credit for the number of credits is associated with a predetermined usage time; and
the application monitoring manager module comprises an automatic exit signal, wherein the automatic exit signal terminates the operation of the plurality of entertainment application.

5. A method of using a computer entertainment tracker application for limiting use of specific computer applications as claimed comprises,
providing an administrator account;
providing a computer program usage limiter;
providing a user manager module, a chore task manager module, an application monitoring manager module, and a user interface;
providing at least one user account;
providing means to manage a pending task list by the chore task manager;
providing an entertainment application list associated with a plurality of entertainment application by the application monitoring manager module;
providing a task schedule by the user interface associating to the at least one user account; and
providing a number of credits associated with the at least one account, wherein each credit is valued by a predetermined usage time.

6. The method of using a computer entertainment tracker application for limiting use of specific computer applications as claimed claim 5 comprises,
providing means to access the user manager module by the administrator account;
providing means to create, edit, and delete user accounts for the at least one user account; and
editing the user accounts to modify access to the plurality of entertainment application.

7. The method of using a computer entertainment tracker application for limiting use of specific computer applications as claimed claim 5 comprises,
providing means to access the chore task manager module by the administrator account; and
providing means to assign chores and tasks from the pending task list to specified user accounts of the at least one user account, wherein each chore and task is associated to a predetermined number of credits and stored to the task schedule.

8. The method of using a computer entertainment tracker application for limiting use of specific computer applications as claimed claim 7 comprises,
providing a completed task list by the chore task manager module, wherein the completed task list includes a plurality of completed task entries awaiting review and approval;
wherein the plurality of completed task entries are associated to a user account of the at least one user account; and
approving of the plurality of completed task entries to grant the predetermined number of credits to the number of credits associated with the chore or task to the at least one user account.

9. The method of using a computer entertainment tracker application for limiting use of specific computer applications as claimed claim 5 comprises,
providing means to access the application monitor manager module by the administrator account; and
adding, via the application monitor manager module, installed entertainment applications to the entertainment application list, wherein the computer program usage limiter refers to the entertainment application list to restrict the operation of the plurality of entertainment application.

10. The method of using a computer entertainment tracker application for limiting use of specific computer applications as claimed claim 5 comprises,
accessing the user interface by the at least one user account;
accessing the task schedule by means of the user interface; and
marking of completed tasks in the user interface, wherein marking of completed tasks notifies the chore task manager module for review and approval.

11. The method of using a computer entertainment tracker application for limiting use of specific computer applications as claimed claim 10 comprises,
utilizing the number of credits to access the plurality of entertainment application through the user interface; and
limiting usage time for the each of the individual entertainment application of the plurality of entertainment application by the computer program usage limiter based on the number of credits associated with the at least one user account.

12. The method of using a computer entertainment tracker application for limiting use of specific computer applications as claimed claim 11 comprises,
providing a timer and a automated exit signal by the application monitoring manager module;
counting by the timer for each operating entertainment application and deducting of credits of the number of credits associated with the at least one user account, wherein credits are deducted every time the predetermined usage time elapses during the use of each entertainment application; and
terminating of the all operating entertainment applications by the automated exit signal when the number of credits is depleted.

13. A computer entertainment tracker application for limiting use of specific computer applications comprises,
a computer program usage limiter;
a user interface;
the computer program usage limiter comprises a user manager module, a chore task manager module, and an application monitoring manager module;
the user manager module having at least one user account;
the chore task manager module having a pending task list;
the application monitoring manager module comprises a timer;
the application monitoring manager module having an entertainment application list associated with a plurality of entertainment application;
the user interface comprises of a task schedule;
the at least one user account having a number of credits, wherein the number of credits permits access to the plurality of entertainment application;
the computer program usage limiter limits the use of the plurality of entertainment application based on the number of credits associated with a user account;
the chore task manager module having a list of completed task;
the list of completed task comprising of a plurality of completed task entries, wherein each of the completed task entries is associated to the at least one user account and each completed task is associated to a predetermined number of credits;
wherein each credit for the number of credits is associated with a predetermined usage time; and
the computer program usage limiter comprises an automatic exit signal, wherein the automatic exit signal terminates the operation of the plurality of entertainment application.
